(19) United States
(12) Patent Application Publication
(10) Pub. No.: US 2017/0345035 A1
(43) Pub. Date: Nov. 30, 2017

(54) MACHINE LEARNING FOR DETERMINING PRODUCTS TO UPSELL OR CROSS-SELL

(71) Applicant: LinkedIn Corporation, Mountain View, CA (US)

(72) Inventors: Wenrong Zeng, Sunnyvale, CA (US); Wei Di, Cupertino, CA (US); Julie Wang, Los Altos, CA (US); Yiying Cheng, Mountain View, CA (US)

(21) Appl. No.: 15/169,441

(22) Filed: May 31, 2016

(51) Int. Cl. G06Q 30/02; H04L 12/26; G06N 99/00

(52) U.S. Cl. CPC G06Q 30/0206; G06N 99/005; H04L 43/16

(57) ABSTRACT

In an example embodiment, a server accesses, for a plurality of customer accounts within a professional networking service, a plurality of features of the customer accounts stored with the professional networking service. The server accesses, for the plurality of customer accounts within the professional networking service, past sales records of products from the professional networking service to the plurality of employer accounts. The server determines, based on the past sales records and based on one or more features from the plurality of features, a product to upsell or cross-sell to a specific customer account. The server provides, as a digital transmission, indicia of the one or more features and the determined product.

### TECHNICAL FIELD

The present disclosure generally relates to machine learning. More specifically, the present disclosure relates to systems and methods of using machine learning for determining products to upsell or cross-sell to customer accounts.

### BACKGROUND

Professional networking services are accessed by professionals in order to network with other professionals or to seek employment or career changes. In this connection, a professional networking services may offer accounts to employers, through which the employers purchase products, such as job listings or job recruiter accounts, within the professional networking service. The professional networking service may employ a sales team to manage the employer accounts and to attempt to upsell (e.g., sell more of an existing product) or cross-sell (e.g., sell a new product) to the employer accounts. In some cases, the upselling or cross-selling attempt is related to a product that is useful and desirable to the company associated with the employer account. The product solves a known need of the company, and the company's employees and managers are grateful for the successful upsell or cross-sell attempt. However, in other cases, the company has no such needs, and the upsell or cross-sell attempt is either rejected outright or leads to a sale that does not meet the company's needs, thereby decreasing the goodwill of the company to the professional networking service. As the foregoing illustrates, machines for determining products to upsell or cross-sell, and employer accounts which would be most interested in the upsell or cross-sell attempt, may be desirable.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a professional networking service, including a data processing module referred to herein as a search engine, for use in generating and providing search results for a search query, consistent with some embodiments of the present disclosure.

FIG. 3 is a flow chart illustrating an example method for determining products to upsell or cross-sell.

FIG. 4 is a block diagram illustrating components of a machine, according to some example embodiments, able to read instructions from a machine-readable medium and perform any of the methodologies discussed herein.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In example embodiments, solutions are provided for a professional networking service to determine products to upsell or cross-sell, and customer accounts which would be most receptive to the upsell or cross-sell attempt.

In accordance with some aspects, a server of a professional networking service accesses, for multiple employer accounts within the professional networking service, multiple features of the employer accounts within the professional networking service. The employer accounts correspond to customers of the professional networking service who purchase products (e.g., job advertisements, recruiter accounts, etc.) from the professional networking service. In some cases, the multiple features include features related to company growth, product booking, product performance, product usage, and product whitespace. In some cases, the multiple features include an industry, a region, a number of employees, a number of employees who are members of the professional networking service, or a hiring growth rate of the employer accounts. An example list of features is provided in Table 1, below.

The server accesses, for the multiple employer accounts within the professional networking service, past sales records of products from the professional networking service to the multiple employer accounts. The past sales records may be associated with products including one or more of a recruiter account within the professional networking service, a job advertisement within the professional networking service, an enhanced company profile within the professional networking service, and an interactive job advertisement within the professional networking service.

The server determines, based on the past sales records and based on one or more features from the multiple features, a product to upsell or cross-sell to a specific employer account. The server provides (e.g., via an electronic message to a machine associated with a sales representative) indicia of the one or more features and the determined product to upsell or cross-sell to the specific employer account.

The subject technology is described herein in conjunction with employer accounts purchasing employment/hiring related products from a professional networking service. However, the subject technology may be useful for other customer accounts and in other contexts. The technology can be extended to any products being sold to any customer accounts.

As used herein, the term “product” encompasses its plain and ordinary meaning and also encompasses the plain and ordinary meaning of “service.” A product may include, for example, a physical, tangible product (e.g., a briefcase, a shirt, and the like), a service (e.g., a cleaning service, a taxi service, and the like), or a digital product (e.g., a digital advertisement, a digital account for accessing a web-based service, and the like).

Returning to the professional networking context, the subject technology provides, among other things, a predictive upsell and cross-sell model which uses machine learning to generate predictions of which products will likely (e.g., with at least a threshold probability) upsell or cross-sell to a given employer account. A product may be upsold to an employer account as an add-on (e.g., not at the end of a contract period, which may be an annual period, a bi-annual period, a semi-annual period, and the like) or in renewal (e.g., when one contract expires and another one is negotiated). For an add-on product, if a sale is closed, then it is an upsell. For a contract renewal, an upsell occurs if the employer account purchases more units of a product than it purchased previously. For example, if ABC Company purchases five recruiter accounts for its human resources employees in 2013 and eight recruiter accounts for its human resources employees in 2014, there was an upsell of three recruiter accounts when the 2014 contract was negotiated. In some cases, an upsell may be determined based on a grade or tier of a product purchased. For example, if DEF Company purchased a silver-tier advertising package in 2014 and a gold-tier advertising package in 2015, there was an upsell when the 2015 contract was negotiated.

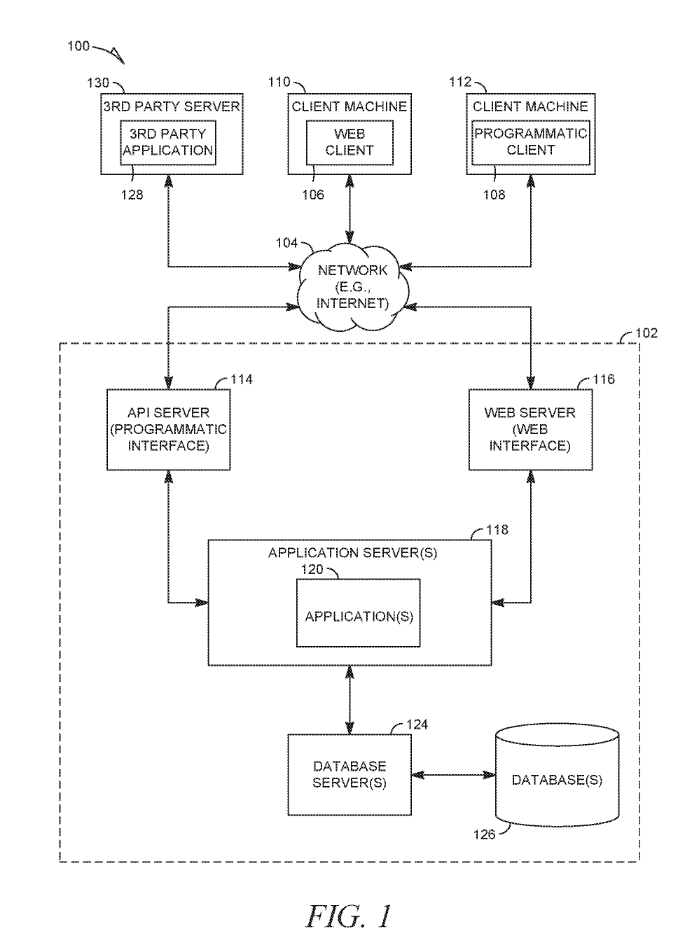

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

In some cases, the application server(s) 118 include application(s) 120 that are configured to access for multiple employer accounts within a professional networking service, multiple features of the employer accounts stored with the professional networking service. The application(s) 120 are configured to access, for the multiple employer accounts within the professional networking service, past sales records of products from the professional networking service to the plurality of employer accounts. The application(s) 120 are configured to determine, based on the past sales records and based on one or more features from the plurality of features, a product to upsell or cross-sell to a specific employer account. The application(s) 120 are configured to provide, as a digital transmission, indicia of the one or more features and the determined product.

As used herein, the term “configured” encompasses its plain and ordinary meaning. In some cases, the application(s) 120 are configured to carry out instructions by having the instructions hard-coded into one or more processors of the application server(s) 118 (e.g., where instructions are stored in firmware, a field programmable gate array (FPGA), or in other such memory or processors). In some cases, the application(s) 120 are configured to carry out instructions by storing software instructions, which are executed by one or more processors of the application server(s) 118 which access the stored software instructions. In some cases, the application(s) 120 include a combination of software and hard-coded instructions.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by a third party. The third party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112, and the third party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

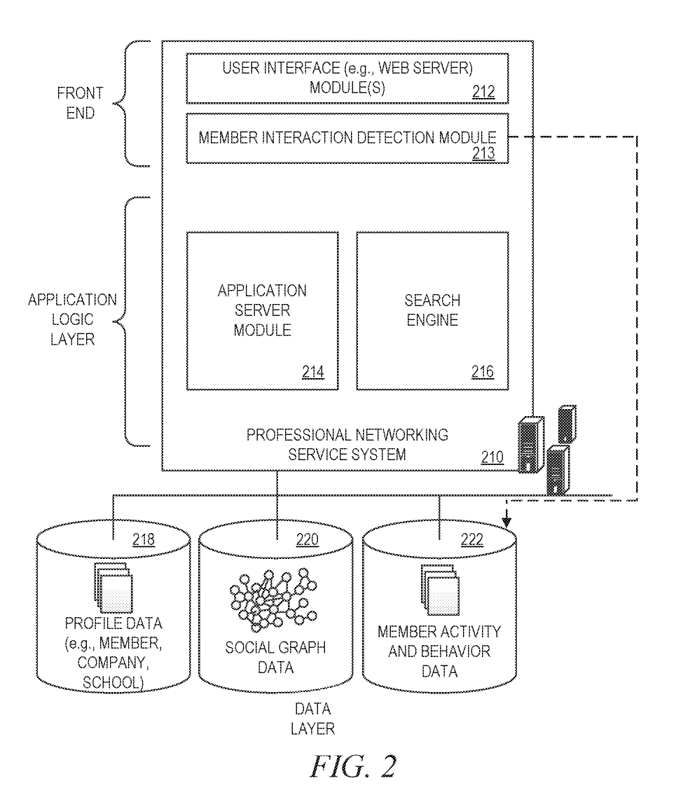

In some embodiments, the networked system 102 may comprise functional components of a professional networking service. FIG. 2 is a block diagram showing the functional components of a professional networking service system 210, including a a search engine 216, for use in generating and providing search results for a search query, consistent with some embodiments of the present disclosure. In some embodiments, the search engine 216 may reside on the application server(s) 118 in FIG. 1. In another embodiment, the search engine 216 resides on the web server 116 or the API server 114. Accordingly, it is contemplated that other configurations are also within the scope of the present disclosure.

As shown in FIG. 2, a front end may comprise a user interface module (e.g., a web server 116) 212, which receives requests from various client computing devices, and communicates appropriate responses to the requesting client devices. For example, the user interface module(s) 212 may receive requests in the form of Hypertext Transfer Protocol (HTTP) requests or other web-based API requests. In addition, a member interaction detection module 213 may be provided to detect various interactions that members have with different applications 120, services, and content presented. As shown in FIG. 2, upon detecting a particular interaction, the member interaction detection module 213 logs the interaction, including the type of interaction and any metadata relating to the interaction, in a member activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the professional networking service.

In some cases, the application server module 214 is configured to access for multiple employer accounts within a professional networking service, and multiple features of the employer accounts stored with the professional networking service. The application server module 214 is configured to access, for the multiple employer accounts within the professional networking service, past sales records of products from the professional networking service to the plurality of employer accounts. The application server module 214 is configured to determine, based on the past sales records and based on one or more features from the plurality of features, a product to upsell or cross-sell to a specific employer account. The application server module 214 is configured to provide, as a digital transmission, indicia of the one or more features and the determined product.

As shown in FIG. 2, the data layer may include several databases, such as a profile database 218 for storing profile data, including both member profile data and profile data for various organizations (e.g., companies, schools, etc.). The profile data may include the employer accounts, and the past sales records and the features of the employer accounts. Consistent with some embodiments, when a person initially registers to become a member of the professional networking service, the person is prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. Similarly, when an employer registers for an employer account, the employer is prompted to provide information about itself, such as its name, geographic location(s), industry, number of employees, and so on. This information is stored, for example, in the profile database 218. Once registered, a member may invite other members, or be invited by other members, to connect via the professional networking service system 210. A “connection” may constitute a bilateral agreement by the members, such that both members acknowledge the establishment of the connection. Similarly, in some embodiments, a member may elect to “follow” another member. In contrast to establishing a connection, the concept of “following” another member typically is a unilateral operation and, at least in some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other objects, are stored and maintained within a social graph in a social graph database 220.

As members interact with the various application(s) 120, services, and content made available via the professional networking service system 210, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the professional networking service system 210 provides an API module via which applications 120 and services can access various data and services provided or maintained by the professional networking service system 210. For example, using an API, an application may be able to request and/or receive one or more navigation recommendations. Such applications 120 may be browser-based applications 120, or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the organization operating the professional networking service system 210, nothing other than data privacy concerns prevents the API from being provided to the public or to certain third parties under special arrangements, thereby making the navigation recommendations available to third party applications 128 and services.

The provided API module may include, for example, a full search API, providing external computing devices, such as client computing devices, with the ability to call full search functions on the professional networking service system 210, and a type ahead API, providing external computing devices, such as client computing devices, with the ability to call type ahead functions on the professional networking service system 210.

Although the search engine 216 is referred to herein as being used in the context of a professional networking service system 210, it is contemplated that it may also be employed in the context of any website or online services. Additionally, although features of the present disclosure are referred to herein as being used or presented in the context of a webpage, it is contemplated that any user interface view (e.g., a user interface on a mobile device or on desktop software) is within the scope of the present disclosure.

In an example embodiment, when member profiles are indexed, forward search indexes are created and stored. The search engine 216 facilitates the indexing and searching for content within the professional networking service system 210, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

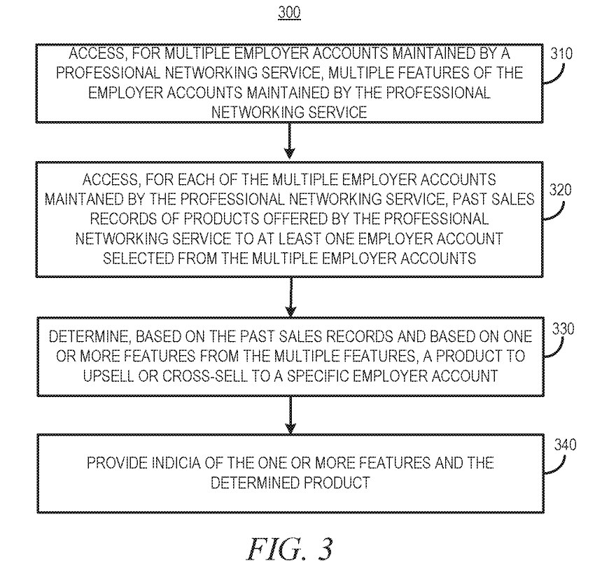

FIG. 3 is a flow chart illustrating an example method 300 for determining products to upsell or cross-sell. In some aspects, the method 300 is implemented at the application server(s) 118 by executing application(s) 120. In some aspects, the method 300 is implemented within the professional networking service system 210 at the application server module 214.

The method 300 begins at operation 310, where a server (e.g., one or more of the application server(s) 118 or one or more servers that host the application server module 214) accesses, for multiple employer accounts maintained by a professional networking service, multiple features of the employer accounts maintained by the professional networking service. In some cases, the features are stored in the profile data 218. In some cases, the features are related to company growth, product booking, product performance, product usage, and product whitespace. In some cases, the features include one or more of an industry, a region, a number of employees, a number of employees who are members of the professional networking service, or a hiring growth rate of the business associated with the employer account. An example set of features is provided in Table 1, below.

The information in Table 1 may be stored in the memory of the server (or a data repository coupled with the server) as a two-dimensional matrix, or any other data structure. In some cases, a two-dimensional matrix stores the multiple features and their relationships with one or more of the company growth, the product booking, the product performance, the product usage, and the product whitespace. The two-dimensional matrix indicates relevance of each of the multiple features to upselling or cross-selling each of the products offered by the professional networking service. In some cases, values for the multiple features are provided by the employer accounts to the server. For example, the employer accounts could indicate where the associated businesses have offices, in which industries they participate, and how quickly they are growing. Alternatively, the server can determine this information automatically, for example, based on an automated search of one or more data repositories (e.g., an automated Internet search).

As used herein, the phrase “product whitespace” encompasses its plain and ordinary meaning. The product whitespace may include a metric to indicate a need or a capacity of a given product that a customer may buy, versus the actual purchase the customer makes on the platform. For example, a company may employ ten recruiters, but only purchase three recruiter accounts from the professional networking service. In this case, the product whitespace is seven recruiter accounts. For tiered product, such as career pages within the professional networking service, the amount of product whitespace may be determined based on whether the customer has a single or multiple segments of its audience (different countries, functionalities, etc.). If the customer has many different segments of audiences (e.g., programmers, intellectual property attorneys, and secretaries in each of North America, Europe, and Asia) the customer may be interested in a higher tier of career pages within the professional networking service.

At operation 320, the server accesses, for each of the multiple employer accounts maintained by the professional networking service, past sales records of products offered by the professional networking service to at least one employer account selected from the multiple employer accounts. The past sales records indicate that a business associated with a given employer account (e.g., ABC Company) purchased a given number of units of a given product (e.g., ten recruiter accounts) during a given time period (e.g., October 2014). In some examples, the products associated with the past sales records include one or more of: a recruiter account within the professional networking service, a job advertisement within the professional networking service, an enhanced company profile within the professional networking service, and an interactive job advertisement within the professional networking service. The past sales records may be stored in the profile data 218 or in the member activity and behavior data 222 of FIG. 2.

At operation 330, the server determines, based on the past sales records and based on one or more features from the multiple features, a product to upsell or cross-sell to a specific employer account. According to some aspects, the product to upsell or cross-sell includes one or more of: a recruiter account within the professional networking service, a job advertisement within the professional networking service, an enhanced company profile within the professional networking service, and an interactive job advertisement within the professional networking service.

According to some examples, the determination of operation 330 is made via machine learning using a training data set. The training data includes a set of records R, where each record R represents a past sales (e.g., upsell or cross-sell) opportunity associated with an employer account. Each record R is represented as a vector G of features <f1, f2, f3, . . . , fn> and a Boolean value S, where f1, f2, f3, . . . , fn are features of the employer account and S is a Boolean indication of whether the sales opportunity resulted in a successful sale or not, with 1 representing a successful sale and 0 representing no sale. The training data is used to predict whether an upsell or cross sell attempt for a particular product will be successful, represented as a probability, as a function F of G. In other words P(sale)=F(G). In the training data set, the P(sale) value is represented with S, which is 0 if there was no sale, or 1 if there was a sale. The function F(G) returns a value of P(sale) which is between 0 and 1, with 0 representing no chance of a sale, 1 representing a guaranteed sale, and 0.85 representing an 85% probability of a successful sale. While some machine learning techniques are described herein, any known machine learning technique can be used in conjunction with the subject technology.

In the training data, the P(sale) value represents whether the upsell/cross-sell attempt was successful or not on a specific product line. Upselling represents selling more of a product that the customer purchased before, cross-selling represents selling a new product to an existing customer. So, if a new recruiter account was upsold to an existing customer (who purchased other recruiter account(s) previously), P(upsell for recruiter account)=1. Otherwise, P(upsell for recruiter account)=0. If the account has not purchased the recruiter product before and now purchases the recruiter product, then P(cross-sell for recruiter account)=1. Otherwise, P(cross-sell for recruiter account)=0.

One example machine learning approach includes constructing, at the server and from the training data set, multiple decision trees to output an indication of whether upselling or cross-selling a given product to a given employer account has a likelihood of success (e.g., a P(sale) value) exceeding a predetermined threshold (e.g., 0.8 or 0.85). Upon determining that upselling or cross-selling the given product to the given employer account has the likelihood of success exceeding the predetermined threshold, indicia of this information are provided as output, as discussed in conjunction with operation 340. The machine learning approach also determines one or more features of the given employer account that were responsible for the determination that upselling or cross-selling the product has the computed probability of success. During the building of the model, the model weighs different features from G based on their importance to or impact on the final prediction. During building, the builder of the model also outputs an importance score i1-n associated with each feature f1-n in G. Thus, after an initial round of building the model, in a second round of building the model, only important features (e.g., features having an importance score above a predetermined threshold) may be considered. The one or more features are identified based on a portion of the decision trees, from the multiple decision trees, that indicated that upselling or cross-selling the product has the likelihood of success exceeding the predetermined threshold. The one or more features are useful to the sales representative in reviewing the information provided by the machine learning approach because the sales representative may know not only which products to upsell or cross-sell, but also why to upsell or cross-sell the products to the employer account. The sales representative may be interested in each feature's importance or in a set of driving features. In some cases, features may be grouped into driving feature sets for presentation to the sales representative. One driving feature set may be affiliation with the professional networking service. Another driving feature set may be spending/budget information of the employer account.

In some cases, the determination of operation 330 is made using a random forest technique and a gradient boosting machine (GBM) technique. The random forest technique is described in Leo Breiman, “Random Forests,” 45 Machine Learning 5-32, 2001, the entire content of which is incorporated herein by reference. As used herein, a random forest may include an ensemble of decision trees that output a prediction value. Each tree in the ensemble is built from a sample drawn with replacement (e.g., a bootstrap sample) from a training set. In addition, when splitting a node during the construction of the tree, the split that is chosen is not necessarily the best split among all of the features. Rather, the split that is selected may be a best split among a random subset of the features. As a result of this randomness, the bias of the forest sometimes slightly increases (with respect to the bias of a single non-random tree) but, due to averaging, its variance also decreases (in some cases, more than compensating for the increase in bias), yielding an overall stronger model.

In some examples, the subject technology uses a random forest that combines classifiers by averaging their probabilistic prediction, instead of letting each classifier vote for a single class. Thus, in some cases, the random forest model outputs probabilities rather than direct labelling (0/1), assisting in the ranking of various employer accounts as possible upsell or cross-sell targets.

The random forest technique can flexibly incorporate missing data in the predictor variables. In some cases, information about employer accounts is missing but may be imputed (e.g., predicted or replaced with substitute data). A random forest may help to mitigate the effect of the missing information. When missing data are encountered for a particular observation during model building, the prediction made for that observation is based on the last preceding (non-terminal) node in the respective tree. Thus, for example, if at a particular point in the sequence of trees a predictor variable is selected at the root (or other non-terminal) node for which some observations have no valid data, then the prediction based on those observations is simply based on the overall mean at the root (or other non-terminal) node. Thus, in some cases, there is no need to eliminate observations (and employer accounts including those observations) from the analysis if they have missing data for some of the predictors. Also, in some cases, there is no need to compute surrogate split statistics.

In some cases, the determination of operation 330 is made using a gradient boosting machine (GBM) technique or tree-based functional gradient descent boosting. Gradient boosting machines are described in Natekin A, Knoll A. Gradient Boosting Machines, a Tutorial. Frontiers in Neurorobotics. 2013; 7:21, the entire content of which is incorporated herein by reference. GBM initializes by building a first tree, then adds new trees that compliment the ones that have already been built, thereby, in some cases, providing better accuracy than random forest with fewer total trees. Relative to random forest, GBM adds new trees that compliment the already built trees, potentially resulting in better accuracy with fewer trees. The GBM algorithm tries to find an optimal linear combination of trees (assuming that the final model is a weighted sum of the predictions of the individual trees) in relation to the given training data.

In some implementations, the subject technology involves a cross-validation for GBM to find the best performance model, and subsequent use of the best performance model. The ensemble approach (random forest together with GBM) is used in the overall model training and prediction.

In some cases, the model may be divided into multiple groups (e.g., five groups), with random forest applied to each group, and then GBM may be applied to combine the data from the multiple groups. This division may be useful because the sales representative may wish to know how (e.g., based on which features) the overall probability of sale value was computed by the combination of random forest and GBM. Thus, sub-models are built for each feature group. For the overall score, some implementations of the subject technology use the combination of random forest and GBM for each sub-model. In some examples, the overall model is labelled RG and each submodel is labelled SR1-5. In one example case where there are 25 features, Equations 1-6 below apply.

P(sale)=RG(f1,f2,f3, . . . f25) Equation 1

Subscore1=SR1(f1,f2,f3,f4,f5) Equation 2

Subscore2=SR2(f6,f7,f8,f9,f10) Equation 3

Subscore3=SR3(f11,f12,f13,f14,f15) Equation 4

Subscore4=SR4(f16,f17,f18,f19,f20) Equation 5

Subscore5=SR5(f21,f22,f23,f24,f25) Equation 6

As shown in Equation 1, the P(sale) value is estimated by applying the full model to all of the features. In addition, as shown in Equations 2-6, the five subscores are estimated based on a portion of the features, which may be related to one another (e.g., budget features, features relevant to the relationship between the employer account and the professional networking service, etc.). The five subscores are used to determine which features of the employer account are most relevant to the determination of the overall P(sale) value, in order to notify the sales representative of these features, so that he/she can use this information in marketing the sale to the employer account.

In summary, the input for the computation of the probability of a sale is a set of features G of an employer account. The features G include, for example, the features f1-f25 set forth in Equations 1-6. The output is a computed probability of the sale, in the range of 0 to 1. The features in G first pass a stage of feature engineering, which may include, for example, imputation, log transform, and binary transform. The transformed features may be represented as G′. G′ may include a subset of the features f1-f25. The length of G′ may be different from that of G (e.g., if two features are combined into one). After G′ is generated, G′ may be directly access by the random forest and GBM algorithms described above. In some cases, a separate upsell and cross-sell model may be built for each of several different products. The products may include one or more of a recruiter account within the professional networking service, a job advertisement within the professional networking service, an enhanced company profile within the professional networking service, and an interactive job advertisement within the professional networking service. The overall model for predicting P(sale) shown in Equation 1 is, according to some aspects, an ensemble model, which includes a combination of random forest and GBM. P(sale) represents a likelihood of an upsell or cross-sell attempt being successful.

In summary, aspects of the subject technology may include a server segregating the plurality of features into a plurality of groups. The server computes, for each group in the plurality of groups, a subscore indicating a probability of a successful upsale or cross-sale of the product based on the features in the group. The server provides, as a digital transmission, indicia of at least one group from the plurality of groups, wherein the subscore for that group exceeds a predetermined threshold.

At operation 340, the server provides indicia of the one or more features, the determined product, and the specific employer account. In some cases, the indicia are provided as a digital transmission to the third party server 130 (e.g., a mail server or mobile messaging server, for transmission to a sales representative as an email message or mobile device message). In some cases, the indicia are provided as a digital transmission to one of the client machines 110 or 112 for display thereat. A user of the client machine 110 or 112 (e.g., a sales representative) may access the client machine 110 or 112 to prepare for a sales call to the business associated with the specific employer account. After operation 340, the method 300 ends.

In this manner, this disclosure provides machine learning techniques for determining products to upsell or cross-sell. A server accesses, for multiple customer accounts within a professional networking service, multiple features of the customer accounts stored with the professional networking service. The server accesses, for the multiple customer accounts within the professional networking service, past sales records of products from the professional networking service to the plurality of employer accounts. The server determines, based on the past sales records and based on one or more features from the multiple features, a product to upsell or cross-sell to a specific customer account. The server provides, as a digital transmission, indicia of the one or more features and the determined product.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-3 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

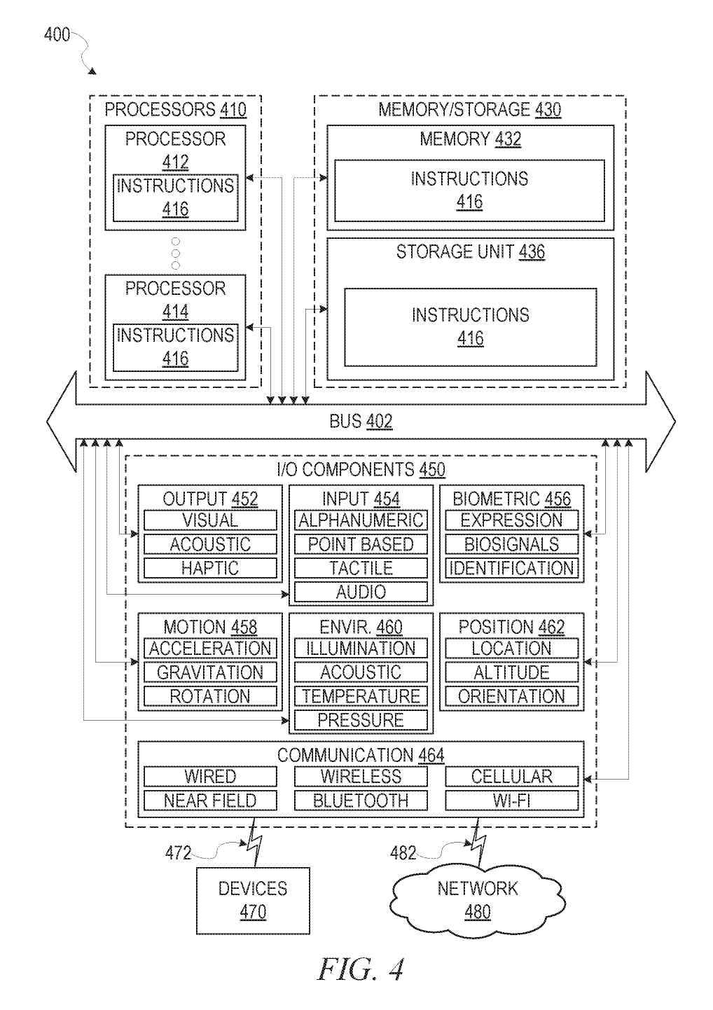

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. The instructions 416 transform the general, non-programmed machine into a particular machine programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory/storage 430, and I/O components 450, which may be configured to communicate with each other such as via a bus 402. In an example embodiment, the processors 410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions contemporaneously. Although FIG. 4 shows multiple processors 410, the machine 400 may include a single processor with a single core, a single processor with multiple cores (e.g., a multi-core processor), multiple processors with a single core, multiple processors with multiples cores, or any combination thereof.

The memory/storage 430 may include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 may also reside, completely or partially, within the memory 432, within the storage unit 436, within at least one of the processors 410 (e.g., within the processor's cache memory), or any suitable combination thereof, during execution thereof by the machine 400. Accordingly, the memory 432, the storage unit 436, and the memory of the processors 410 are examples of machine-readable media.

As used herein, “machine-readable medium” means a device able to store instructions (e.g., instructions 416) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 416. The term “machine-readable medium” shall also be taken to include any medium, or combination of multiple media, that is capable of storing instructions (e.g., instructions 416) for execution by a machine (e.g., machine 400), such that the instructions, when executed by one or more processors of the machine (e.g., processors 410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion and the grouping is in no way limiting. In various example embodiments, the I/O components 450 may include output components 452 and input components 454. The output components 452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or other suitable device to interface with the network 480. In further examples, the communication components 464 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., a peripheral device coupled via a USB).

Moreover, the communication components 464 may detect identifiers or include components operable to detect identifiers. For example, the communication components 464 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 480 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., HTTP). Similarly, the instructions 416 may be transmitted or received using a transmission medium via the coupling 472 (e.g., a peer-to-peer coupling) to the devices 470. The term “transmission medium” shall be taken to include any intangible medium that is capable of storing, encoding, or carrying the instructions 416 for execution by the machine 400, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

### Table Appendix

Table 1, below, provides a list of features used in some implementations of the subject technology. In Table 1, the “feature name” column provides the name of a feature. The “description” column provides a description of the feature. The “feature group” column provides a group, selected from a set of groups, with which the feature is associated. The “recruiter account” column indicates whether the feature is relevant to cross-selling the recruiter account in the professional networking service, with Y indicating yes and N indicating no. The “job ad slot” column indicates whether the feature is relevant to cross-selling job advertisement slots in the professional networking service. The “enhanced company profile” column indicates whether the feature is relevant to cross-selling enhanced company profiles in the professional networking service. The “interactive job ad” column indicates whether the feature is relevant to cross-selling interactive job advertisements in the professional networking service.

TABLE 1

| | | | | | Enhanced | Interactive |
|---|---|---|---|---|---|---|
| Feature | | Feature | Recruiter | Job Ad | Company | Job |
| Name | Description | Group | Account | Slot | Profile | Ad |
| cmp_posts_s3 | # of Company Posts in recent | Company | Y | Y | Y | Y |
| | 3 months | Growth | | | | |
| cmp_posts_s4 | # of Company Posts in recent | Company | Y | Y | Y | Y |
| | 1 month | Growth | | | | |
| conn_cmp_s3 | # of Connections in recent 3 | Company | Y | Y | Y | Y |
| | months | Growth | | | | |
| conn_cmp_s4 | # of Connections in recent 1 | Company | Y | Y | Y | Y |
| | month | Growth | | | | |
| new_dm_s1 | # of New DM Join in recent | Company | Y | Y | Y | Y |
| | 12 months | Growth | | | | |
| new_dm_s2 | # of New DM Join in recent 6 | Company | Y | Y | Y | Y |
| | months | Growth | | | | |
| new_dm_s3 | # of New DM Join in recent 3 | Company | Y | Y | Y | Y |
| | months | Growth | | | | |
| new_dm_s4 | # of New DM Join in recent 1 | Company | Y | Y | Y | Y |
| | month | Growth | | | | |
| new_hire_12 mo | # of New Hires Join in recent | Company | Y | Y | Y | Y |
| | 12 months | Growth | | | | |
| new_hire_1 mo | # of New Hires Join in recent | Company | Y | Y | Y | Y |
| | 1 month | Growth | | | | |
| new_hire_3 mo | # of New Hires Join in recent | Company | Y | Y | Y | Y |
| | 3 months | Growth | | | | |
| new_hire_6 mo | # of New Hires Join in recent | Company | Y | Y | Y | Y |
| | 6 months | Growth | | | | |
| new_rc_s1 | # of New Recruiters Join in | Company | Y | Y | Y | Y |
| | recent 12 months | Growth | | | | |
| new_rc_s2 | # of New Recruiters Join in | Company | Y | Y | Y | Y |
| | recent 6 months | Growth | | | | |
| new_rc_s3 | # of New Recruiters Join in | Company | Y | Y | Y | Y |
| | recent 3 months | Growth | | | | |
| new_rc_s4 | # of New Recruiters Join in | Company | Y | Y | Y | Y |
| | recent 1 month | Growth | | | | |
| new_tp_s1 | # of New Talent Professionals | Company | Y | Y | Y | Y |
| | Join in recent 12 months | Growth | | | | |
| new_tp_s2 | # of New Talent Professionals | Company | Y | Y | Y | Y |
| | Join in recent 6 months | Growth | | | | |
| new_tp_s3 | # of New Talent Professionals | Company | Y | Y | Y | Y |
| | Join in recent 3 months | Growth | | | | |
| new_tp_s4 | # of New Talent Professionals | Company | Y | Y | Y | Y |
| | Join in recent 1 month | Growth | | | | |
| num_emp_follow_s3 | # of Employee Followers in | Company | Y | Y | Y | Y |
| | recent 3 months | Growth | | | | |
| num_emp_follow_s4 | # of Employee Followers in | Company | Y | Y | Y | Y |
| | recent 1 month | Growth | | | | |
| num_follower_s3 | # of Followers in recent 3 | Company | Y | Y | Y | Y |
| | months | Growth | | | | |
| num_follower_s4 | # of Followers in recent 1 | Company | Y | Y | Y | Y |
| | month | Growth | | | | |
| num_mmb_s3 | # of LI Members in recent 3 | Company | Y | Y | Y | Y |
| | months | Growth | | | | |
| num_mmb_s4 | # of LI Members in recent 1 | Company | Y | Y | Y | Y |
| | month | Growth | | | | |
| orig_onboard_flag | Is the original opportunity | Company | Y | Y | Y | Y |
| | “New Biz”? | Growth | | | | |
| account_tier | Account Tier (eg. Small Biz, | Company | Y | Y | Y | Y |
| | Enterprise, Strategic | Growth | | | | |
| | Accounts) | | | | | |
| acct_galileo_segment | Account Galileo Marketing | Company | Y | Y | Y | Y |
| | Segment | Growth | | | | |
| acct_industry | Account Industry | Company | Y | Y | Y | Y |
| | | Growth | | | | |
| acct_region | Account Region | Company | Y | Y | Y | Y |
| | | Growth | | | | |
| admin_seat_s3 | # of Admin Seats in recent 3 | Product | Y | Y | Y | Y |
| | months | Booking | | | | |
| admin_seat_s4 | # of Admin Seats in recent 1 | Product | Y | Y | Y | Y |
| | month | Booking | | | | |
| cap_dprice_usd | Recruiter Discounted Price | Product | N | Y | Y | Y |
| | Total (USD) | Booking | | | | |
| cap_qty | # of Recruiter Seats | Product | N | Y | Y | Y |
| | | Booking | | | | |
| job_dprice_usd | Job Slot Discounted Price | Product | Y | N | Y | Y |
| | (USD) | Booking | | | | |
| job_qty | # of Job Slots | Product | Y | N | Y | Y |
| | | Booking | | | | |
| job_wrapping | Has Job Wrapping? | Product | Y | N | Y | Y |
| | | Booking | | | | |
| lcp_dprice_usd | LCP Discounted Price (USD) | Product | Y | Y | N | Y |
| | | Booking | | | | |
| lcp_type | LCP Type | Product | Y | Y | N | Y |
| | | Booking | | | | |
| lcp_yn | Has LCP? | Product | Y | Y | N | Y |
| | | Booking | | | | |
| lms_bookings_q3 | LMS bookings in Q3 | Product | Y | Y | Y | Y |
| | | Booking | | | | |
| lms_bookings_q4 | LMS bookings in Q4 | Product | Y | Y | Y | Y |
| | | Booking | | | | |
| recruiter_online_q3 | # of Online Recuiter License | Product | Y | Y | Y | Y |
| | in Q3 | Booking | | | | |
| recruiter_online_q4 | # of Online Recuiter License | Product | Y | Y | Y | Y |
| | in Q4 | Booking | | | | |
| tp_seat_s3 | Average # of TP Seats Per | Product | Y | Y | Y | Y |
| | Month in recent 3 months | Booking | | | | |
| tp_seat_s4 | Average # of TP Seats Per | Product | Y | Y | Y | Y |
| | Month in recent 1 month | Booking | | | | |
| wwu_dprice_usd | WWU Discounted Price | Product | Y | Y | Y | N |
| | (USD) | Booking | | | | |
| wwu_yn | Has WWU? | Product | Y | Y | Y | N |
| | | Booking | | | | |
| crr_viewers_q3 | # of LCP Viewers in Q3 | Product | Y | Y | N | Y |
| | | Performance | | | | |
| crr_viewers_q4 | # of LCP Viewers in Q4 | Product | Y | Y | N | Y |
| | | Performance | | | | |
| crr_views_q3 | # of LCP Views in Q3 | Product | Y | Y | N | Y |
| | | Performance | | | | |
| crr_views_q4 | # of LCP Views in Q4 | Product | Y | Y | N | Y |
| | | Performance | | | | |
| job_applicant_s3 | Average # of Job Applicants | Product | Y | N | Y | Y |
| | Per Job Per Month in recent 3 | Performance | | | | |
| | months | | | | | |
| job_applicant_s4 | Average # of Job Applicants | Product | Y | N | Y | Y |
| | Per Job Per Month in recent 1 | Performance | | | | |
| | month | | | | | |
| job_apply_click_s3 | Average # of Job Apply | Product | Y | N | Y | Y |
| | Clicks Per Job Per Month in | Performance | | | | |
| | recent 3 months | | | | | |
| job_apply_click_s4 | Average # of Job Apply | Product | Y | N | Y | Y |
| | Clicks Per Job Per Month in | Performance | | | | |
| | recent 1 month | | | | | |
| job_inpact_12 mo | # of Impacted Hires by Job | Product | Y | N | Y | Y |
| | Slot in recent 12 months | Performance | | | | |
| job_inpact_1 mo | # of Impacted Hires by Job | Product | Y | N | Y | Y |
| | Slot in recent 1 month | Performance | | | | |
| job_inpact_3 mo | # of Impacted Hires by Job | Product | Y | N | Y | Y |
| | Slot in recent 3 months | Performance | | | | |
| job_inpact_6 mo | # of Impacted Hires by Job | Product | Y | N | Y | Y |
| | Slot in recent 6 months | Performance | | | | |
| job_view_s3 | Average # of Job Views Per | Product | Y | N | Y | Y |
| | Month in recent 3 months | Performance | | | | |
| job_view_s4 | Average # of Job Views Per | Product | Y | N | Y | Y |
| | Month in recent 1 month | Performance | | | | |
| job_viewer_s3 | Average # of Job Viewers Per | Product | Y | N | Y | Y |
| | Month in recent 3 months | Performance | | | | |
| job_viewer_s4 | Average # of Job Viewers Per | Product | Y | N | Y | Y |
| | Month in recent 1 month | Performance | | | | |
| lcp_inpact_12 mo | # of Impacted Hires by LCP | Product | Y | Y | N | Y |
| | in recent 12 months | Performance | | | | |
| lcp_inpact_1 mo | # of Impacted Hires by LCP | Product | Y | Y | N | Y |
| | in recent 1 month | Performance | | | | |
| lcp_inpact_3 mo | # of Impacted Hires by LCP | Product | Y | Y | N | Y |
| | in recent 3 months | Performance | | | | |
| lcp_inpact_6 mo | # of Impacted Hires by LCP | Product | Y | Y | N | Y |
| | in recent 6 months | Performance | | | | |
| rec_inpact_12 mo | # of Impacted Hires by | Product | N | Y | Y | Y |
| | Recruiters in recent 12 | Performance | | | | |
| | months | | | | | |
| rec_inpact_1 mo | # of Impacted Hires by | Product | N | Y | Y | Y |
| | Recruiters in recent 1 month | Performance | | | | |
| rec_inpact_3 mo | # of Impacted Hires by | Product | N | Y | Y | Y |
| | Recruiters in recent 3 months | Performance | | | | |
| rec_inpact_6 mo | # of Impacted Hires by | Product | N | Y | Y | Y |
| | Recruiters in recent 6 months | Performance | | | | |
| wwu_clk_s3 | Average # of WWU Clicks | Product | Y | Y | Y | N |
| | Per Month in recent 3 months | Performance | | | | |
| wwu_clk_s4 | Average # of WWU Clicks | Product | Y | Y | Y | N |
| | Per Month in recent 1 month | Performance | | | | |
| wwu_imp_s3 | Average # of WWU | Product | Y | Y | Y | N |
| | Impressions in recent 3 | Performance | | | | |
| | months | | | | | |
| wwu_imp_s4 | Average # of WWU | Product | Y | Y | Y | N |
| | Impressions in recent 1 month | Performance | | | | |
| wwu_inpact_12 mo | # of Impacted Hires by WWU | Product | Y | Y | Y | N |
| | in recent 12 months | Performance | | | | |
| wwu_inpact_1 mo | # of Impacted Hires by WWU | Product | Y | Y | Y | N |
| | in recent 1 month | Performance | | | | |
| wwu_inpact_3 mo | # of Impacted Hires by WWU | Product | Y | Y | Y | N |
| | in recent 3 months | Performance | | | | |
| wwu_inpact_6 mo | # of Impacted Hires by WWU | Product | Y | Y | Y | N |
| | in recent 6 months | Performance | | | | |
| avg_inmail_apt_s3 | Monthly Average Inmail | Product | N | Y | Y | Y |
| | Accepted Per Seat in recent 3 | Usage | | | | |
| | months | | | | | |
| avg_inmail_apt_s4 | Monthly Average Inmail | Product | N | Y | Y | Y |
| | Accepted Per Seat in recent 1 | Usage | | | | |
| | month | | | | | |
| avg_inmail_snt_s3 | Monthly Average Inmail Sent | Product | N | Y | Y | Y |
| | Per Seat in recent 3 months | Usage | | | | |
| avg_inmail_snt_s4 | Monthly Average Inmail Sent | Product | N | Y | Y | Y |
| | Per Seat in recent 1 month | Usage | | | | |
| avg_profile_view_s3 | Monthly Average Profile | Product | N | Y | Y | Y |
| | View Per Seat in recent 3 | Usage | | | | |
| | months | | | | | |
| avg_profile_view_s4 | Monthly Average Profile | Product | N | Y | Y | Y |
| | View Per Seat in recent 1 | Usage | | | | |
| | month | | | | | |
| avg_search_s3 | Monthly Average Search Per | Product | N | Y | Y | Y |
| | Seat in recent 3 months | Usage | | | | |
| avg_search_s4 | Monthly Average Search Per | Product | N | Y | Y | Y |
| | Seat in recent 1 month | Usage | | | | |
| cap_training_q3 | # of Recruiter Trainings in Q3 | Product | N | Y | Y | Y |
| | | Usage | | | | |
| cap_training_q4 | # of Recruiter Trainings in Q4 | Product | N | Y | Y | Y |
| | | Usage | | | | |
| job_training_q3 | # of Job Slot Trainings in Q3 | Product | Y | N | Y | Y |
| | | Usage | | | | |
| job_training_q4 | # of Job Slot Trainings in Q4 | Product | Y | N | Y | Y |
| | | Usage | | | | |
| jobs_per_slot_s3 | Average # of Job Posts Per | Product | Y | N | Y | Y |
| | Slot Per Month in recent 3 | Usage | | | | |
| | months | | | | | |
| jobs_per_slot_s4 | Average # of Job Posts Per | Product | Y | N | Y | Y |
| | Slot Per Month in recent 1 | Usage | | | | |
| | month | | | | | |
| login_rate_s3 | Average Login Rate Per | Product | Y | Y | Y | Y |
| | Month in recent 3 months | Usage | | | | |
| login_rate_s4 | Average Login Rate Per | Product | Y | Y | Y | Y |
| | Month in recent 1 month | Usage | | | | |
| seat_share_ratio_s3 | Seat Sharing Ratio in recent 3 | Product | N | Y | Y | Y |
| | months | Usage | | | | |
| seat_share_ratio_s4 | Seat Sharing Ratio in recent 1 | Product | N | Y | Y | Y |
| | month | Usage | | | | |
| seats_need_cap_training | Does the client need seat | Product | N | Y | Y | Y |
| | training? | Usage | | | | |
| hire_cntr_s3 | Average # of Hiring | Product | Y | Y | Y | Y |
| | Countries Per Month in recent | Whitespace | | | | |
| | 3 months | | | | | |
| hire_cntr_s4 | Average # of Hiring | Product | Y | Y | Y | Y |
| | Countries Per Month in recent | Whitespace | | | | |
| | 1 month | | | | | |
| hire_func_s3 | Average # of Hiring | Product | Y | Y | Y | Y |
| | Functionalities Per Month in | Whitespace | | | | |
| | recent 3 months | | | | | |
| hire_func_s4 | Average # of Hiring | Product | Y | Y | Y | Y |
| | Functionalities Per Month in | Whitespace | | | | |
| | recent 1 month | | | | | |
| hire_ind_s3 | Average # of Hiring | Product | Y | Y | Y | Y |
| | Industries Per Month in recent | Whitespace | | | | |
| | 3 months | | | | | |
| hire_ind_s4 | Average # of Hiring | Product | Y | Y | Y | Y |
| | Industries Per Month in recent | Whitespace | | | | |
| | 1 month | | | | | |
| job_cntr_s3 | Average # of Countries of Job | Product | Y | N | Y | Y |
| | Posting Per Month in recent 3 | Whitespace | | | | |
| | months | | | | | |
| job_cntr_s4 | Average # of Countries of Job | Product | Y | N | Y | Y |
| | Posting Per Month in recent 1 | Whitespace | | | | |
| | month | | | | | |
| job_ind_s3 | Average # of Industries of Job | Product | Y | N | Y | Y |
| | Posting Per Month in recent 3 | Whitespace | | | | |
| | months | | | | | |
| job_ind_s4 | Average # of Industries of Job | Product | Y | N | Y | Y |
| | Posting Per Month in recent 1 | Whitespace | | | | |
| | month | | | | | |
| job_whitespace_s3 | Average # of Job Whitespaces | Product | Y | N | Y | Y |
| | Per Month in recent 3 months | Whitespace | | | | |
| job_whitespace_s4 | Average # of Job Whitespaces | Product | Y | N | Y | Y |
| | Per Month in recent 1 month | Whitespace | | | | |
| lcp_continent_num_s3 | Average # of LCP Viewers' | Product | Y | Y | N | Y |
| | Continent Per Month in recent | Whitespace | | | | |
| | 3 months | | | | | |
| lcp_continent_num_s4 | Average # of LCP Viewers' | Product | Y | Y | N | Y |
| | Continent Per Month in recent | Whitespace | | | | |
| | 1 month | | | | | |
| lcp_country_num_s3 | Average # of LCP Viewers' | Product | Y | Y | N | Y |
| | Countries Per Month in recent | Whitespace | | | | |
| | 3 months | | | | | |
| lcp_country_num_s4 | Average # of LCP Viewers' | Product | Y | Y | N | Y |
| | Countries Per Month in recent | Whitespace | | | | |
| | 1 month | | | | | |
| lcp_func_num_s3 | Average # of LCO | Product | Y | Y | N | Y |
| | Functionalities Per Month in | Whitespace | | | | |
| | recent 3 months | | | | | |
| lcp_func_num_s4 | Average # of LCO | Product | Y | Y | N | Y |
| | Functionalities Per Month in | Whitespace | | | | |
| | recent 1 month | | | | | |
| lcp_industry_num_s3 | Average # of LCO Industries | Product | Y | Y | N | Y |
| | Per Month in recent 3 months | Whitespace | | | | |
| lcp_industry_num_s4 | Average # of LCO Industries | Product | Y | Y | N | Y |
| | Per Month in recent 1 month | Whitespace | | | | |
| seat_whitespace_s3 | Average # of Seat | Product | N | Y | Y | Y |
| | Whitespaces in recent 3 | Whitespace | | | | |
| | months | | | | | |
| seat_whitespace_s4 | Average # of Seat | Product | N | Y | Y | Y |
| | Whitespaces in recent 1 | Whitespace | | | | |
| | month | | | | | |
| wwu_viewer_cmp_cnt_s3 | Average # of ProfileViewers' | Product | Y | Y | Y | Y |
| | Employers Per Month in | Whitespace | | | | |
| | recent 3 months | | | | | |
| wwu_viewer_cmp_cnt_s4 | Average # of ProfileViewers' | Product | Y | Y | Y | Y |
| | Employers Per Month in | Whitespace | | | | |
| | recent 3 months | | | | | |

What is claimed is:

1. A method comprising:
accessing, by one or more hardware processors, for a plurality of customer accounts maintained by a professional networking service, a plurality of features of the customer accounts maintained by the professional networking service;
accessing, by the one or more hardware processors, for each of the plurality of customer accounts maintained by the professional networking service, past sales records of products offered by the professional networking service to at least one customer account selected from the plurality of customer accounts;
determining, by the one or more hardware processors, based on the past sales records and based on one or more features from the plurality of features, a product to upsell or cross-sell to a specific customer account, wherein determining the product to upsell or cross-sell to the specific customer account comprises: machine learning using a training data set, the training data set comprising: (i) a set of past features and a set of past sales records for the plurality of customer accounts, and (ii) a set of successful or failed upsell or cross-sell attempts for the products from a given time period in the past; and
providing, as a digital transmission, indicia of the one or more features and the determined product.

2. The method of claim 1, wherein the plurality of features of the customer accounts comprise features related to one or more of: company growth, product booking, product performance, product usage, and product whitespace, and wherein a two-dimensional matrix stores the plurality of features and indicates their relationships with the one or more of the company growth, the product booking, the product performance, the product usage, and the product whitespace.

3. The method of claim 1, wherein the plurality of features of the customer accounts comprise one or more of: an industry, a region, a number of employees, a number of employees who are members of the professional networking service, and a hiring growth rate, the method further comprising:
determining values for the plurality of features based on an automated search of one or more data repositories.

4. The method of claim 1, wherein the plurality of features are listed within a two-dimensional matrix, and wherein the two-dimensional matrix indicates relevance of each of the plurality of features to upselling or cross-selling each of the products offered by the professional networking service.

5. The method of claim 1, wherein determining the product to upsell or cross-sell to the specific customer account comprises:
constructing a plurality of decision trees to output an indication of whether upselling or cross-selling the product has a likelihood of success exceeding a predetermined threshold, an input for the plurality of decision trees comprising at least a portion of the plurality of features; and
determining, using the constructed plurality of decision trees, that upselling or cross-selling the product has the likelihood of success exceeding the predetermined threshold.

6. The method of claim 1, further comprising:
segregating the plurality of features into a plurality of groups;
computing, for each group in the plurality of groups, a subscore indicating a probability of a successful upsale or cross-sale of the product based on the features in the group; and
providing, as a digital transmission, indicia of at least one group from the plurality of groups, wherein the subscore for the at least one group exceeds a predetermined threshold.

7. The method of claim 1, wherein:
the products associated with the past sales records comprise one or more of: a recruiter account within the professional networking service, a job advertisement within the professional networking service, an enhanced company profile within the professional networking service, and an interactive job advertisement within the professional networking service; and
the product to upsell or cross-sell is selected from among the products.

8. A non-transitory machine-readable medium storing instructions which, when executed by one or more processors of a machine, cause the machine to implement operations comprising:
accessing, by one or more hardware processors of the machine, for a plurality of customer accounts maintained by a professional networking service, a plurality of features of the customer accounts maintained by the professional networking service;
accessing, by the one or more hardware processors, for each of the plurality of customer accounts maintained by the professional networking service, past sales records of products offered by the professional networking service to at least one customer account selected from the plurality of customer accounts;
determining, by the one or more hardware processors, based on the past sales records and based on one or more features from the plurality of features, a product to upsell or cross-sell to a specific customer account, wherein determining the product to upsell or cross-sell to the specific customer account comprises: machine learning using a training data set, the training data set comprising: (i) a set of past features and a set of past sales records for the plurality of customer accounts, and (ii) a set of successful or failed upsell or cross-sell attempts for the products from a given time period in the past; and
providing, as a digital transmission, indicia of the one or more features and the determined product.

9. The machine-readable medium of claim 8, wherein the plurality of features of the customer accounts comprise features related to one or more of: company growth, product booking, product performance, product usage, and product whitespace, and wherein a two-dimensional matrix stores the plurality of features and indicates their relationships with the one or more of the company growth, the product booking, the product performance, the product usage, and the product whitespace.

10. The machine-readable medium of claim 8, wherein the plurality of features of the customer accounts comprise one or more of: an industry, a region, a number of employees, a number of employees who are members of the professional networking service, and a hiring growth rate, the operations further comprising:
determining values for the plurality of features based on an automated search of one or more data repositories.

11. The machine-readable medium of claim 8, wherein the plurality of features are listed within a two-dimensional matrix, and wherein the two-dimensional matrix indicates relevance of each of the plurality of features to upselling or cross-selling each of the products offered by the professional networking service.

12. The machine-readable medium of claim 8, wherein determining the product to upsell or cross-sell to the specific customer account comprises:
constructing a plurality of decision trees to output an indication of whether upselling or cross-selling the product has a likelihood of success exceeding a predetermined threshold, an input for the plurality of decision trees comprising at least a portion of the plurality of features; and
determining, using the constructed plurality of decision trees, that upselling or cross-selling the product has the likelihood of success exceeding the predetermined threshold.

13. The machine-readable medium of claim 8, the operations further comprising:
segregating the plurality of features into a plurality of groups;
computing, for each group in the plurality of groups, a subscore indicating a probability of a successful upsale or cross-sale of the product based on the features in the group; and
providing, as a digital transmission, indicia of at least one group from the plurality of groups, wherein the subscore for the at least one group exceeds a predetermined threshold.

14. The machine-readable medium of claim 8, wherein:
the products associated with the past sales records comprise one or more of: a recruiter account within the professional networking service, a job advertisement within the professional networking service, an enhanced company profile within the professional networking service, and an interactive job advertisement within the professional networking service; and
the product to upsell or cross-sell is selected from among the products.

15. A system comprising:
one or more hardware processors; and
a memory comprising instructions which, when executed by the one or more hardware processors, cause the one or more hardware processors to implement operations comprising:
accessing, by the one or more hardware processors, for a plurality of customer accounts maintained by a professional networking service, a plurality of features of the customer accounts maintained by the professional networking service;
accessing, by the one or more hardware processors, for each of the plurality of customer accounts maintained by the professional networking service, past sales records of products offered by the professional networking service to at least one customer account selected from the plurality of customer accounts;
determining, by the one or more hardware processors, based on the past sales records and based on one or more features from the plurality of features, a product to upsell or cross-sell to a specific customer account, wherein determining the product to upsell or cross-sell to the specific customer account comprises: machine learning using a training data set, the training data set comprising: (i) a set of past features and a set of past sales records for the plurality of customer accounts, and (ii) a set of successful or failed upsell or cross-sell attempts for the products from a given time period in the past; and
providing, as a digital transmission, indicia of the one or more features and the determined product.

16. The system of claim 15, wherein the plurality of features of the customer accounts comprise features related to one or more of: company growth, product booking, product performance, product usage, and product whitespace, and wherein a two-dimensional matrix stores the plurality of features and indicates their relationships with the one or more of the company growth, the product booking, the product performance, the product usage, and the product whitespace.

17. The system of claim 15, wherein the plurality of features of the customer accounts comprise one or more of: an industry, a region, a number of employees, a number of employees who are members of the professional networking service, and a hiring growth rate, the operations further comprising:
determining values for the plurality of features based on an automated search of one or more data repositories.

18. The system of claim 15, wherein the plurality of features are listed within a two-dimensional matrix, and wherein the two-dimensional matrix indicates relevance of each of the plurality of features to upselling or cross-selling each of the products offered by the professional networking service.

19. The system of claim 15, wherein determining the product to upsell or cross-sell to the specific customer account comprises:
constructing a plurality of decision trees to output an indication of whether upselling or cross-selling the product has a likelihood of success exceeding a predetermined threshold, an input for the plurality of decision trees comprising at least a portion of the plurality of features; and
determining, using the constructed plurality of decision trees, that upselling or cross-selling the product has the likelihood of success exceeding the predetermined threshold.

20. The system of claim 15, the operations further comprising:
segregating the plurality of features into a plurality of groups;
computing, for each group in the plurality of groups, a subscore indicating a probability of a successful upsale or cross-sale of the product based on the features in the group; and
providing, as a digital transmission, indicia of at least one group from the plurality of groups, wherein the subscore for the at least one group exceeds a predetermined threshold.
